(19) United States
(12) Patent Application Publication
(10) Pub. No.: US 2010/0164914 A1
(43) Pub. Date: Jul. 1, 2010

(54) VOLTAGE FEEDBACK CIRCUIT FOR ACTIVE MATRIX REFLECTIVE DISPLAY DEVICES

(75) Inventor: Micheal Cassidy, Dublin (IE)

Correspondence Address: VOLPE AND KOENIG, P.C., UNITED PLAZA, SUITE 1600, 30 SOUTH 17TH STREET, PHILADELPHIA, PA, 19103, US

(73) Assignee: NTERA LIMITED, Dublin (IE)

(21) Appl. No.: 12/527,151

(22) PCT Filed: Feb. 13, 2008
(86) PCT No.: PCT/US08/01863

§ 371 Date: Feb. 12, 2010

Related U.S. Application Data
(60) Provisional application No. 60/889,667, filed on Feb. 13, 2007.

(51) Int. Cl. G09G 5/00

(52) U.S. Cl. 345/205

(57) ABSTRACT

The present invention is a driving circuit for use with reflective display devices. In a preferred embodiment, the display device is a pixilated, active matrix electrochromic device. The inventive circuit includes a sampling capacitor and a plurality of inverters. The sampling circuit quickly stores a data voltage. Addressing of a plurality of electrochromic pixels in an active matrix is thereby accelerated. The inverters are coupled to a relatively high and low power source for quickly driving the electrochromic pixel to the stored data voltage. The circuit of the present invention permits rapid refreshing of electrochromic pixels in an active matrix and achieves color gradients without bleaching and recharging the electrochromic pixel.

### FIELD OF INVENTION

The present invention generally relates to circuitry for driving reflective display devices and in particular, electrochemical display devices.

### BACKGROUND

Reflective display devices are fundamentally different than today's typical display devices. Reflective display devices reflect incident light whereas typical display devices selectively mask a light source. Typical display devices include cathode ray tubes (CRT), liquid crystal displays (LCD), and plasma displays. In all of these examples of typical display devices a light source is selectively masked or colored to create an image. Reflective displays, on the other hand, selectively reflect incident light to create an image. Examples of reflective displays include electrochromic displays, electrophoretic displays, electrowetting displays, dielectrophoresis displays, and anisotropically rotating ball displays. Reflective displays do not require backlighting, produce excellent contrast ratios, and are easily viewable in bright ambient light, such as outdoors.

Electrochromic compounds exhibit a reversible color change when the compounds gain or lose electrons. Single segment electrochromic devices that exploit the inherent properties of electrochromic compounds find application in large area static displays and automatically dimming mirrors, and are well known. Multiple segment electrochromic display devices create images by selectively modulating light that passes through a controlled region containing an electrochromic compound. A multitude of controlled electrochromic regions may individually function as pixels to collectively create a high resolution image. Typically, these display devices contain a reflective layer underneath the electrochromic compound, respective to the viewer, for reflecting light allowed to pass beyond the electrochromic region. Simply put, the electrochromic pixel acts as a shutter either blocking light or allowing light to pass through to the underlying reflective layer.

A typical prior art electrochromic display device 10, as shown in FIG. 1, includes a base substrate 10, typically glass or plastic, which supports a transparent conductor layer 20, which may be, for example, a layer of fluorine doped tin oxide (FTO) or indium doped tin oxide (ITO). A nanoporous-nanocrystalline semi-conducting film 30, (herein referred to simply as a nano-structured film 30), is deposited, preferably by way of screen printing with an organic binder, on the transparent conductor 20. The nano-structured film is typically a doped metal oxide, such as antimony tin oxide (ATO). Optionally, a redox reaction promoter compound is adsorbed on the nano-structured film 30. An ion-permeable reflective layer 40, typically white titanium dioxide (TiO₂), is optionally deposited, preferably by way of screen printing with an organic binder followed by sintering, on the nano-structured film 30.

A second substrate 50, which is transparent, supports a transparent conductor layer 60, which may be a layer of FTO or ITO. A nano-structured film 70 having a redox chromophore 75, typically a 4,4′-bipyridinium derivative compound, adsorbed thereto is deposited on the transparent conductor 60, by way of a self-assembled mono-layer deposition from solution.

The base substrate 10 and the second substrate 50 are then assembled with an electrolyte 80 placed between the ion-permeable reflective layer 40 and the nano-structured film 70 having an adsorbed redox chromophore 75. A potential applied across the cathode electrode 90 and the anode electrode 100 reduces the adsorbed redox chromophore 75, thereby producing a color change. Reversing the polarity of the potential reverses the color change. When the redox chromophore 75 is generally black or very deep purple in a reduced state, a viewer 110 perceives a generally black or very deep purple color. When the redox chromophore 75 is in an oxidized state and generally clear, a viewer 110 will perceive light reflected off of the ion-permeable reflective layer 40, which is generally white. In this manner, a black and white display is realized by a viewer 110.

Electrochromic display devices such as the one described above are described in greater detail in U.S. Pat. No. 6,301,038 and U.S. Pat. No. 6,870,657, both to Fitzmaurice et al., which are herein incorporated by reference.

The electrochromic display 10 shown in FIG. 1 is a pixilated display, having individual image elements, (i.e. pixels A, B, and C). The potential applied to each pixel A, B, and C is provided by a dedicated routing track in the transparent conductive layer 60. Each pixel A, B, and C is therefore directly driven; a voltage applied to pixel A will not interfere with pixels B or C. In order to create a large electrochromic display capable of displaying high resolution images, a large number of pixels is required, and therefore a large number of direct drive routing tracks. For a typical computer monitor having millions of pixels, fabricating millions of direct drive routing tracks is impractical.

To reduce the complexity of providing each pixel with its own direct drive routing track, an active matrix may be used. In an active matrix, each pixel has an active component for electrically isolating each pixel from all other pixels and for matrix addressing of each pixel. FIG. 2A is a schematic illustration of an active matrix 200 for controlling a plurality of pixels addressed in rows R₁ . . . R₄ and columns C₁ . . . C₇. A multitude of active devices 210, typically transistors, are located at the intersection of each row and column. Referring to FIGS. 2A and 2B, each active device 210 includes a gate electrode 220, a source electrode 230 and a drain electrode 240. The cathode 250 of each pixel 260 is electrically connected to the drain electrode 240 of the active device 210. The anode 270 of the pixel 260 is commonly connected across all pixels.

To write data to a desired pixel 260, for example the pixel 260 at the intersection of row R₂ and column C₂, a row signal is applied to row R₂ to activate the active device 210, while a different row signal is applied to all other rows (i.e. rows R₁, R₃, and R₄) to ensure active devices 210 in these rows are kept inactive. A column signal is then applied on column C₂ to write data to the pixel 210. Typically, an entire row of pixels will be updated simultaneously by writing data to each pixel in a selected row at the same time. In this manner, a large number and high density of pixels may be individually controlled while maintaining electrical isolation of each pixel.

Typically, an active matrix is constructed from thin film transistors (TFTs). The fabrication of TFTs is well known in the art and includes the deposition of opaque metal layers on an insulative substrate. Therefore, TFTs are not transparent or translucent. Furthermore, in order to achieve optimal switching times and performance in an electrochromic display of the kind described above, the drain of each TFT must be on the cathode side of the display (i.e. on the side contained the nano-structured film with adsorbed viologen). Achieving active control of pixels A, B, and C in the electrochromic display 10 therefore requires placement of opaque TFTs on the front plane of the display, with respect to the viewer 110. This is disadvantageous as opaque TFTs diminish the reflectivity of the display, reduce pixel aperture, and adversely affect contrast ratio and apparent brightness of the display.

In addition to reducing pixel aperture, prior art electrochromic device drive circuitry produces slow switching times of the electrochromic pixel, lacks the capability to provide multiple levels of coloration, and is incapable of driving an electrochromic pixel without first bleaching the pixel. Typically, prior art driving circuitry is powered by a single DC potential. Accordingly, the driving circuitry simply provides an on or off signal to the pixel without the ability to provide intermediate voltages. Prior art driving circuitry also lacks the ability to compensate for the instantaneous pixel state and for non-uniformities in the driving circuitry.

Therefore, driving circuitry for active matrix reflective displays that overcomes the above disadvantages is desired.

### SUMMARY

The present invention is a driving circuit for use with reflective display devices and in particular, electrochromic devices. In a preferred embodiment, an electrochromic display device is a pixilated, active matrix device. The inventive circuit includes a sampling capacitor and a plurality of inverters.

The sampling circuit quickly stores a data voltage. Addressing of a plurality of electrochromic pixels in an active matrix is thereby accelerated. The plurality of inverters is coupled to a relatively high and low power source for quickly driving the electrochromic pixel to the stored data voltage. The circuit of the present invention permits rapid refreshing of electrochromic pixels in an active matrix and achieves color gradients without bleaching and recharging the electrochromic pixel.

### BRIEF DESCRIPTION OF THE DRAWINGS

A more detailed understanding of the invention may be had from the following description, given by way of example and to be understood in conjunction with the accompanying drawings, wherein:

FIG. 1 is a direct-drive prior art electrochromic display device;

FIG. 2A is a schematic illustration of an active matrix for controlling a plurality of pixels in a display device;

FIG. 2B is a schematic illustration of a single active element of the active matrix of FIG. 2A;

FIG. 3 is a schematic diagram of the voltage feedback circuit according to a preferred embodiment of the present invention; and

FIG. 4 is an active matrix electrochromic display device comprising a reflective insulating layer and the voltage feedback circuit of FIG. 3 in accordance with a preferred embodiment of the present invention.

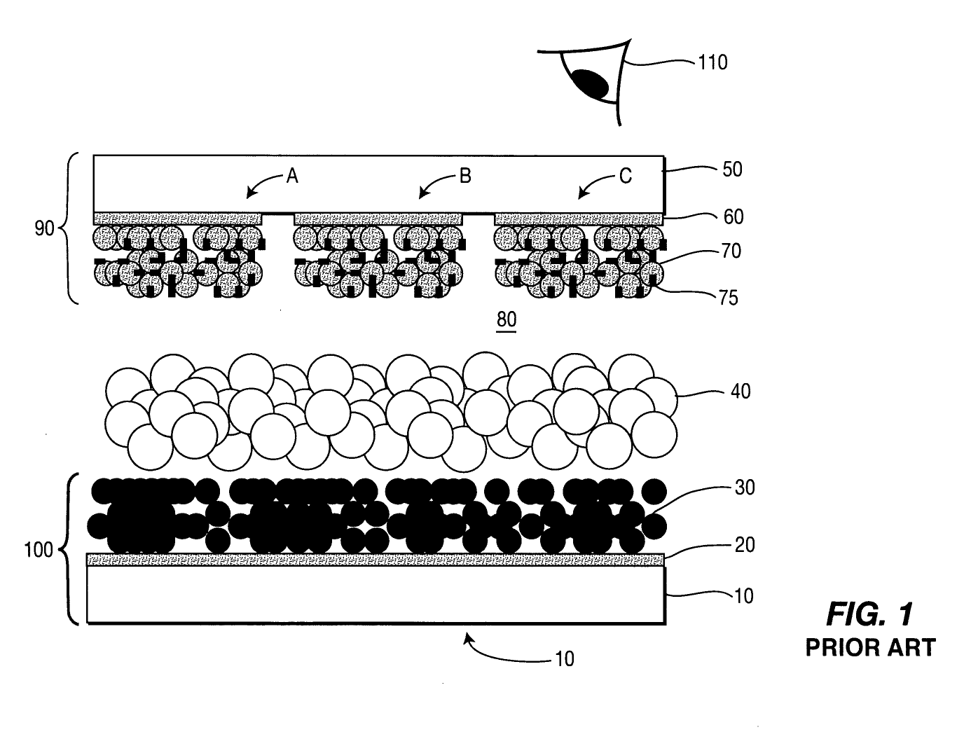

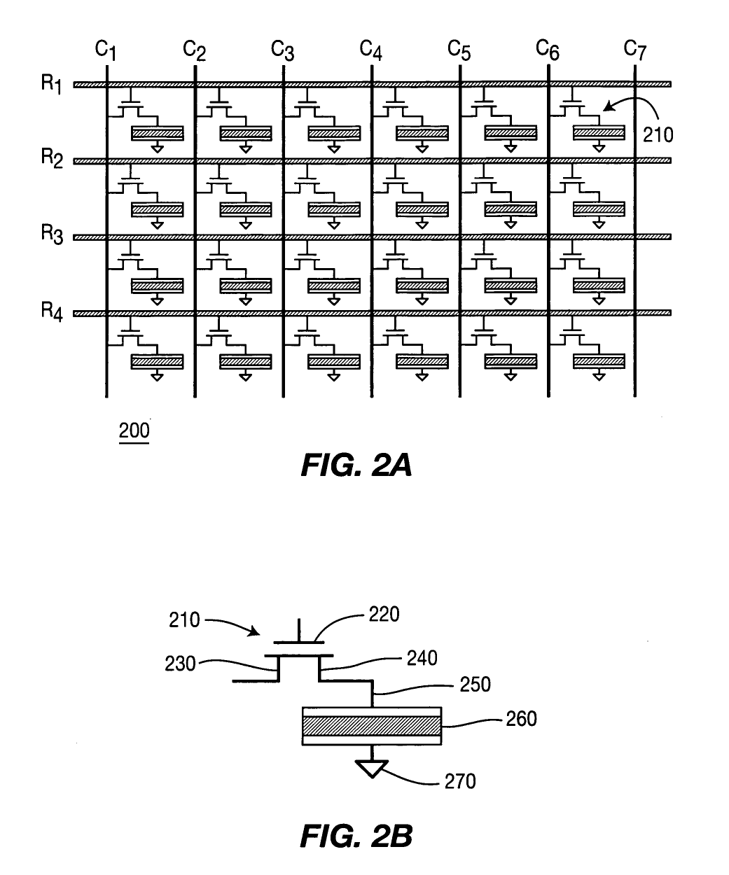

### DETAILED DESCRIPTION OF THE PREFERRED EMBODIMENTS

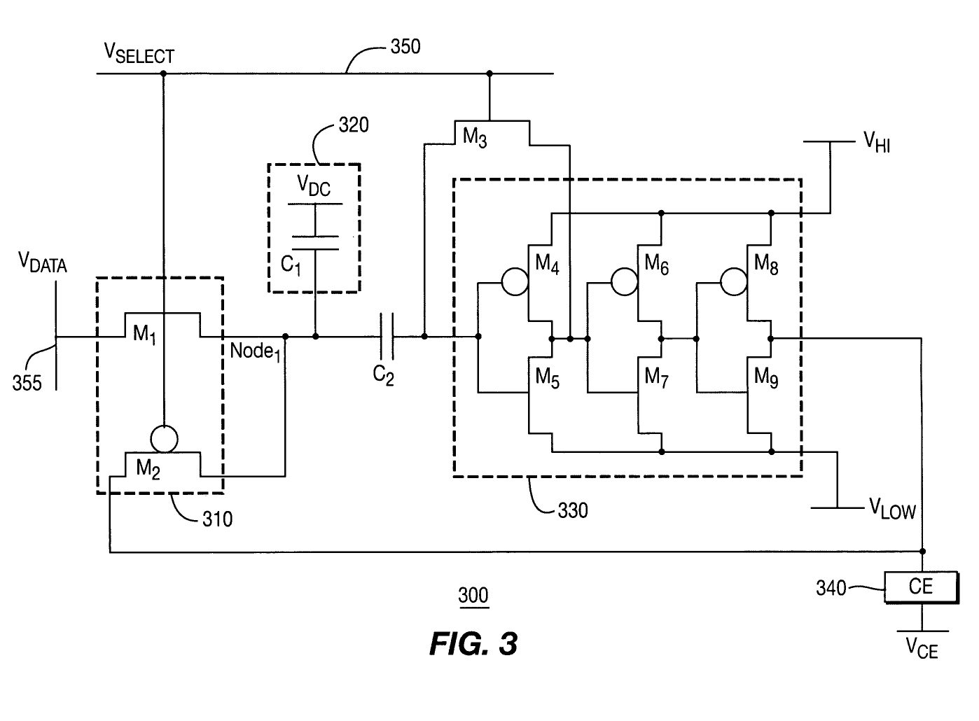

Referring to FIG. 3, a circuit 300 for overcoming the disadvantages of the prior art in accordance with the present invention is shown. Circuit 300 includes a switch 310, a sampling capacitor 320, and a plurality of inverters 330, and is coupled to an electrochromic pixel 340. In a preferred embodiment, the circuit 300 is located at the intersection of a matrix of V_{select} electrodes and V_{data} electrodes. However, it is noted that the circuit 300 may also be used in a segmented direct drive electrochromic device.

The circuit 300 uses a sampling capacitor thereby allowing a data voltage to be programmed into the circuit when its associated electrochromic pixel 340 is selected. The electrochromic pixel 340 may then be charged while it is deselected and the remaining pixels of the display device are addressed. This allows the entire display to be updated at much faster refresh rates than previously achieved in the prior art.

In order to address a given electrochromic pixel 340, a selection electrode 355 of a matrix is selected. In order to write data to the given electrochromic pixel 340, the data electrode 355 provides a data voltage V_{data} to the electrochromic pixel 340. The voltage difference at transistor M₁, which is an n-type transistor, switches the transistor M₁. Node 1 is therefore charged with the data voltage of V_{data}. The sampling capacitor 320, C₁ is likewise charged to the data voltage V_{data}.

During the addressing phase, transistor M₃ is switched on and conducting, thereby holding the first stage of the inverter 330 (i.e. transistors M₄ and M₅) in a metastable state between the high voltage source Vₕᵢ and the low voltage source V_{low}. Transistor M₂ is off during the row address period, thereby isolating the electrochromic pixel 340 from Node 1.

When the selection electrode 350 is deselected, Node 1 becomes isolated from the data electrode 355 and is now coupled through the transistor M₂ to the electrochromic pixel 340. Capacitor C₂ is selected such that the capacitance of the electrochromic pixel 340 is much larger than that of the capacitor C₂. The voltage at Node 1 therefore is approximately equivalent to the voltage stored in the electrochromic pixel 340. Transistor M₃ no longer couples the input and output of the first inverter (i.e. M₄ and M₅) and the voltage change at Node 1 is coupled through C₂ to the input of the first inverter (i.e. M₄ and M₅). The first inverter (i.e. M₄ and M₅) and the second inverter (i.e. M₆ and M₇) apply a voltage gain to the coupled signal such that the third inverter (i.e. M₈ and M₉) are driven into saturation. The specific transistor of the third inverter, either M₈ or M₉ that is driven into saturation depends on the voltage difference between V_{data}(t−1) and V_{data}(t), where t is a given time sample.

The high and low source voltages Vₕᵢ and V_{low} are preferably relatively high and low voltages sources with respect to the typical driving voltage of the electrochromic pixel. When the third inverter is driven into saturation with the appropriate voltage, the electrochromic pixel 340 is charged at a faster rate than by simply charging the pixel 340 directly with V_{data}.

As the voltage on the electrochromic pixel 340 changes, the change is coupled through capacitor C₂ to the input of the first inverter (i.e. M₄ and M₅) forcing it back towards its original meta-stable point. The inputs of the second inverter (i.e. M₆ and M₇) and the third inverter (i.e. M₈ and M₉) are also forced to the meta-stable voltage point. In the case where the working voltage range of the electrochromic pixel 340 is relatively close to the meta-stable voltage, the static state position of the circuit will ensure minimum static power consumption.

The circuit 300 minimizes image artifacts due to transistor non-uniformity as the final state on the electrochromic pixel 340 is independent of the threshold and the mobility of the transistors M₁ through M₉. The feedback loop design of the circuit 300 forces the inverters 330 to stop charging the electrochromic pixel 340 when the desired voltage level has been reached on the pixel's 340 electrode.

Preferably, during non-addressing periods, for example when the electrochromic pixel 340 is in a bistable mode, the high and low voltage sources Vₕᵢ and V_{low} are brought to the meta-stable voltage, thereby minimizing power consumption. In a preferred embodiment, the metastable voltage is selected to be zero (0) volts.

In the event that data to be written to the electrochromic pixel 340 does not change over a certain time period, no voltage will be coupled through capacitor C₂ and the circuit 300 will remain static. In this scenario, there is no need for bleaching stages or for power consuming charging as is required with prior art driving circuits.

Preferably, the threshold voltages of n-type and p-type transistors M₁ through M₉ are asymmetric about the mean operating point. In this embodiment, a new operating voltage range for the electrochromic pixel 340 may be chosen that minimizes the static power consumption in the circuit. In another embodiment, capacitor C₁ is omitted altogether, as the voltage will be stored at Node 1.

As part of the driving scheme, the charge injection of transistor M₃ may be accounted for by incorporating a voltage offset on the voltage signal V_{data}. This principle may also be used to adjust for any charge injection effects from the switching of M₁. These techniques will help reduce the required size of the sampling capacitor C₁. This voltage offset will preferably be performed in gamma adjustment circuitry, or elsewhere in the driving signal path.

It is noted that P-type and N-type transistors may be interchanged while maintaining the fundamental principle of operation of the circuit 300. Implementations with solely n-type or solely p-type devices may be used. Preferably, the transistors are a combination of n-channel metal-oxide-semiconductor field-effect (NMOS) TFTs and p-channel metal-oxide-semiconductor field effect (PMOS) TFTs, collectively known as complementary metal-oxide-semiconductor field effect (CMOS) TFTs. Alternatively, organic TFTs, or any other type of active device may be used. Capacitor and transistor non-uniformity will mean that the time required to charge the electrochromic pixel 340 will vary slightly from pixel to pixel. However, the minimum charging time and the transistor sizes may be specified as a function of the minimum transistor performance by fabrication. Therefore, minimum acceptable performance is guaranteed with a given refresh period.

In an alternative embodiment, an additional transistor (not shown) is added across the input and output of the 1^{st} inverter 330. This additional transistor is preferably a P-type transistor and assists in counteracting the charge injection due to the switching of transistor M₃. The additional transistor includes a gate signal coupled to the inverse signal of the selection electrode 350.

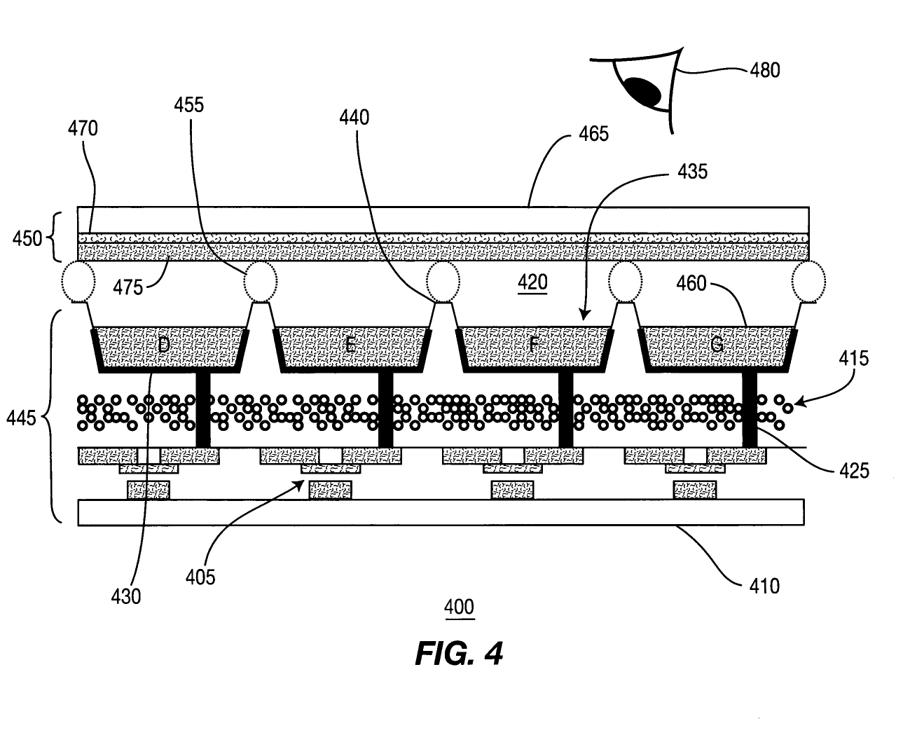

In a preferred embodiment, referring to FIG. 4, an active matrix electrochromic device 400 comprising a plurality of driving circuits 405 in accordance with the present invention deposited on a backplane substrate 410 is shown. It should be noted that the electrochromic display 400 contains 4 pixels D, E, F, and G, purely for illustrative purposes. Each pixel D, E, F, and G have a respective driving circuit 305 for driving that pixel. The backplane substrate 410 is preferably glass, but may be any material capable of supporting the driving circuits 405 and subsequent layers comprising the electrochromic display 400. For example, the backplane substrate 410 may comprise materials such as plastic, wood, leather, fabrics of various composition, metal, and the like. Accordingly, these materials may be rigid or flexible.

An insulating layer 415 is deposited on the driving circuits 405. The insulating layer 415 is substantially impermeable to the electrolyte 420, thereby protecting the driving circuits 405 from the possible corrosive effects of the electrolyte 420. Preferably, the insulating layer 415 is a spin-coated glass or polymer, such as polyimide. The insulating layer 415 may be a single, monolithic layer, or it may comprise multiple layers of identical or different materials having desired properties to achieve a desired three dimensional structure. In a preferred embodiment, the insulating layer 415 is reflective. The reflective property of the insulating layer 415 may be inherent in the material that comprises the layer, or reflective particles may be interspersed in the insulating layer 415.

An operable connection 425, known in the art as a via, is provided in the insulating layer for electrically connecting the driving circuits 405 to a conductor 430. Preferably, the operable connection 425 is created via photolithographic techniques, which are well known to those skilled in the art. Each operable connection, or via, 425 extends generally upwardly through the insulating layer 415 and is in electrical contact with a respective conductor 430, which preferably covers the bottom and the sides of a plurality of wells 435 formed or etched into the insulating layer 415. The operable connection 425 (i.e. via) and conductor 430 are preferably both transparent, and are preferably FTO, ITO or a conductive polymer.

The wells 435 are preferably etched in the insulating layer 415 using photolithographic techniques. Alternatively, the wells 435 are formed by mechanically embossing a deposited planar film or by application of a film containing a preformed waffle-type structure defining the wells 435.

Partitions 440 maintain electrical isolation of each well 435, and also allow the wells 435 to act as receptacles for ink-jet deposited materials. Partitions 440 may further act as a spacer between the cathode 445 and anode 450 of the electrochromic device 400, and serve to reduce ionic crosstalk between pixels through the electrolyte 420. The partitions 440 further serve the purpose of a visual boundary between each well 435, and may be sized as desired to achieve optimal appearance of each well 435. It should be noted that although the partitions are shown as greatly extended generally above the wells 435, they may alternatively be generally flush with the top of the wells 435.

A semiconducting layer 460 having an adsorbed electrochromophore is deposited on the conductor 430. Preferably, the semiconducting layer 460 is a nano-structured metallic oxide semiconducting film, as described hereinbefore. The semiconducting metallic oxide may be an oxide of any suitable metal, such as, for example, titanium, zirconium, hafnium, chromium, molybdenum, tungsten, vanadium, niobium, tantalum, silver, zinc, strontium, iron (Fe²⁺ or Fe³⁺) or nickel or a perovskite thereof. TiO₂, WO₃, MoO₃, ZnO, and SnO₂ are particularly preferred. Most preferably, the nano-structured film is titanium dioxide (TiO₂), and the adsorbed electrochromophore is a compound of the general formulas I-III:

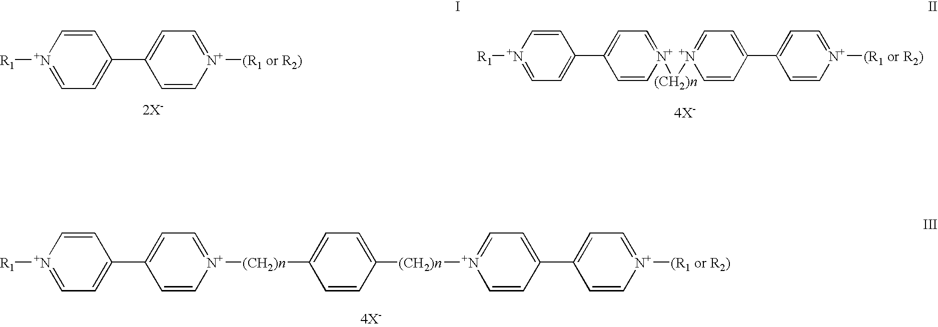

R₁ is selected from any of the following:

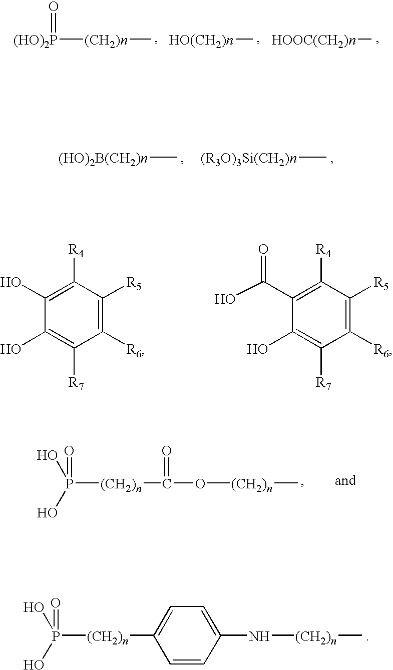

R₂ is selected from C₁₋₁₀ alkyl, N-oxide, dimethylamino, acetonitrile, benzyl, phenyl, benzyl mono- or di-substituted by nitro; phenyl mono- or di-substituted by nitro. R₃ is C₁₋₁₀ alkyl and R₄, R₅, R₆, and R₇ are each independently selected from hydrogen, C₁₋₁₀ alkyl, C₁N₀ alkylene, aryl or substituted aryl, halogen, nitro, and an alcohol group. X is a charge balancing ion, and n=1-10.

Compounds of the formulae I-III are well known and may be prepared as described in Solar Energy Materials and Solar Cells, 57, (1999), 107-125 which is hereby incorporated by reference in its entirety. In a preferred embodiment, the adsorbed electrochromophore is bis-(2-phosphonoethyl)-4,4′-bipyridinium dichloride.

In an alternative embodiment, the reflective insulating layer 415 may be generally flat and electrical isolation of each pixel's D, E, F, and G transparent conductor 430 and semiconducting layer 460 is achieved by spatial separation, an additional isolating layer, or other isolating means. The corrosive effects of the electrolyte 420 on the driving circuits 405 are still prevented by the insulating layer 415 in this alternative configuration. Optionally, selectively sized spacer beads 455 may be used to maintain a desired spacing between the cathode 445 and the anode 450.

A frontplane substrate 465, which is substantially transparent, supports a substantially transparent conductor 470. The substrate 465 may be any suitable transparent material, such as glass or plastic. The material may be rigid or flexible. FTO, ITO, or any other suitable transparent conductor may be used for the transparent conductor 470.

A semiconducting layer 475 is deposited on the transparent conductor 470. Preferably, the semiconducting layer 475 is a nano-structured metallic oxide semiconducting film comprising Sb doped SnO₂. In an alternative embodiment, the semiconducting layer 475 includes an adsorbed redox promoter for assisting oxidation and reduction of electrochromic compounds adsorbed to the semiconducting layer 460 of the cathode 445.

The electrochromic display 400 is assembled by placing the anode electrode 450 onto the cathode electrode 445, ensuring that the two electrodes 445, 450 do not touch. Preferably, a flexible seal is formed around the perimeter, ensuring that the electrodes 445, 450 do not touch. Alternatively, physical separation of the cathode electrode 445 and the anode electrode 450 may be ensured by first depositing spacer beads 455 or other spacer structures as mentioned herein. The partitions 440 formed on the insulating layer 415 may also act to maintain a separation between the cathode electrode 445 and anode electrode 450. It should be noted that the anode electrode 450 covers the entire area of the pixels D, E, F, and G and is not segmented into individual areas corresponding to the area of the pixels D, E, F, and G. An electrolyte 420 is provided between the electrodes 445, 450, preferably by back-filling in a vacuum chamber.

An electric potential applied across the cathode electrode 445 and the anode electrode 450 induces the flow of electrons in the semiconducting layer 460 having adsorbed electrochromophores. Upon oxidation and reduction, the adsorbed electrochromophores change color. Preferably, the adsorbed electrochromophores are substantially black in a reduced state and generally transparent in an oxidized state. A viewer 480 perceives a pixel containing a reduced adsorbed electrochromophore as a generally black pixel. Viewer 480 perceives a pixel containing an oxidized adsorbed electrochromophore (i.e. a transparent adsorbed electrochromophore) as the color of the underlying reflective insulating layer 415. In this manner, an active matrix electrochromic display is realized.

Alternatively, each well 435 may contain a semiconducting layer 460 having adsorbed electrochromophores that exhibit different color properties. For example, adsorbed electrochormophores that appear red, green, and blue in a reduced state and transparent in an oxidized state may be used. In this alternative embodiment, reflective insulating layer 415 is preferably white. By selectively applying a potential to each pixel, the appearance of each pixel D, E, F, and G may be switched between the colored state of the electrochromophore and the color of the underlying reflective insulating layer 415.

While the above embodiments have been described in combination with an electrochromic display device, this is merely exemplary. The inventive driving circuit may be used with any type of reflective display device, such as electrophoretic displays, electrowetting displays, dielectrophoresis displays, anisotropically rotating ball displays, and other types of reflective display devices.

Although the features and elements of the present invention are described in the preferred embodiments in particular combinations, each feature or element can be used alone without the other features and elements of the preferred embodiments or in various combinations with or without other features and elements of the present invention.

1-22. (canceled)

23. A method of charging a reflective display pixel, the method comprising:
electrically isolating the reflective display pixel from a data line in response to commencement of an addressing phase;
storing a data signal received from the data line;
coupling the reflective display pixel to the stored data signal in response to completion of the addressing phase;
amplifying the data signal to produce a driving signal; and
applying the driving signal to the reflective display pixel;
feeding back an electrical potential of the reflective display pixel such that the electrical potential of the reflective display pixel becomes equal to the stored data signal.

24. The method of claim 1, wherein the reflective display pixel is an electrochromic pixel.

25. The method of claim 2, wherein the electrochromic pixel is included in an active matrix electrochromic device.

26. The method of claim 3, wherein the electrochromic pixel is electrically isolated from the active matrix by way of a transistor.

27. The method of claim 1, wherein the data signal is stored on a capacitor.

28. The method of claim 1, wherein the data signal is amplified by a plurality of inverters to produce the driving signal.

29. A circuit for charging a reflective display pixel, the circuit comprising:
means for selectively isolating the reflective display pixel from a data signal in response to commencement of an addressing phase;
means for sampling the data signal;
means for coupling the reflective display pixel to the means for sampling the data signal in response to completion of the addressing phase;
means for amplifying the data signal to produce a driving potential;
means for applying the driving potential to the reflective display pixel; and
means for feedback of an electrical potential of the reflective display pixel such that the electrical potential of the reflective display becomes equal to the sampled data signal.

30. The circuit of claim 7, wherein the reflective display pixel is an electrochromic pixel.

31. The circuit of claim 7, wherein the means for selecticely isolating the reflective display pixel from a data signal comprises:
a first transistor, wherein a source of the first transistor is coupled to the data line, a gate of the first transistor is coupled to a selection line, and a drain of the first transistor is coupled to a capacitor.

32. The circuit of claim 9, wherein the means for selecticely isolating the reflective display pixel from a data signal further comprises:
a second transistor, wherein a source of the second transistor is coupled to an electrode of the reflective display pixel, a drain of the second transistor is coupled to the capacitor, and a gate of the second transistor is coupled to the selection line.

33. The circuit of claim 10, wherein the means for selecticely isolating the reflective display pixel from a data signal further comprises:
a third transistor, wherein a source of the third transistor is coupled to the capacitor, a drain of the second transistor is coupled to an output of means for amplifying the data signal to produce a driving potential, and a gate of the third transistor is coupled to the selection line.

34. The circuit of claim 7, wherein the means for amplifying the data signal to produce a driving potential comprises:
a pull-up device having a source coupled to a relatively high voltage source; and
a pull-down device having a source coupled to a relatively low voltage source.

35. The circuit of claim 7, wherein the means for amplifying the data signal to produce a driving potential comprises:
a p-type transistor having a source coupled to a relatively high voltage source; and
an n-type transistor having a source coupled to a relatively low voltage source.
